(19) United States
(12) Patent Application Publication
(10) Pub. No.: US 2024/0051579 A1
(43) Pub. Date: Feb. 15, 2024

(54) INFORMATION PROCESSING APPARATUS, INFORMATION PROCESSING SYSTEM, INFORMATION PROCESSING METHOD, AND VEHICLE

(71) Applicant: TOYOTA JIDOSHA KABUSHIKI KAISHA, Toyota-shi (JP)

(72) Inventors: Toshiki KASHIWAKURA, Ota-ku (JP); Ai MIYATA, Sakai-shi (JP); Kotaro HIROSE, Nisshin-shi (JP); Sho MINAGAWA, Nisshin-shi (JP); Yuki UCHIDA, Iwakura-shi (JP); Tsuyoshi OKADA, Nagoya-shi (JP)

(73) Assignee: TOYOTA JIDOSHA KABUSHIKI KAISHA, Toyota-shi (JP)

(21) Appl. No.: 18/363,991

(22) Filed: Aug. 2, 2023

(30) Foreign Application Priority Data
Aug. 9, 2022 (JP) 2022-127445

(51) Int. Cl. B60W 60/00; G01C 21/34; B60J 3/04; B60K 35/00

(52) U.S. Cl. CPC B60W 60/0025; G01C 21/343; B60J 3/04; B60K 35/00; B60K 2370/194; B60K 2370/785

(57) ABSTRACT

An information processing apparatus includes a controller configured to manage operation of a vehicle traveling in a facility. The controller is configured to determine a tour schedule to allow users touring the facility to be on board the vehicle so that a visible range to the users is limited based on an attribute of the users, and control the vehicle based on the tour schedule.

### CROSS-REFERENCE TO RELATED APPLICATION

This application claims priority to Japanese Patent Application No. 2022-127445, filed on Aug. 9, 2022, the entire contents of which are incorporated herein by reference.

### TECHNICAL FIELD

The present disclosure relates to an information processing apparatus, an information processing system, an information processing method, and a vehicle.

### BACKGROUND

Systems that operate sightseeing buses to cover desired sightseeing spots selected by prospective passengers of the sightseeing buses are known (e.g., Patent Literature (PTL) 1 and the like).

### CITATION LIST

### Patent Literature

PTL 1: JP 2002-279031 A

### SUMMARY

All sightseeing spots are openly shown to visitors to the sightseeing spots. On the other hand, when visitors to a facility, such as a factory, are allowed to be on board a vehicle and tour the facility, it may not be possible to open all of the facility. Therefore, there is room for improvement in systems that allow visitors to facilities, such as factories, to be on board vehicles and tour the facilities.

It would be helpful to improve systems that allow visitors to facilities, such as factories, to be on board vehicles and tour the facilities.

An information processing apparatus according to an embodiment of the present disclosure includes a controller configured to manage operation of a vehicle traveling in a facility. The controller is configured to determine a tour schedule to allow a user touring the facility to be on board the vehicle so that a visible range to the user is limited based on an attribute of the user. The controller is configured to control the vehicle based on the tour schedule.

An information processing system according to an embodiment of the present disclosure includes the information processing apparatus and a vehicle whose operation is managed by the information processing apparatus.

An information processing method according to an embodiment of the present disclosure includes:
managing operation of a vehicle traveling in a facility;
determining a tour schedule to allow a user touring the facility to be on board the vehicle so that a visible range to the user is limited based on an attribute of the user; and
controlling the vehicle based on the tour schedule.

A vehicle according to an embodiment of the present disclosure is configured to travel in a facility with a user touring the facility on board. The vehicle includes a controller configured to control traveling of the vehicle based on a tour schedule determined based on an attribute of the user, and a window configured to allow the user to see the facility from inside the vehicle. The controller is configured to control the window so that a visible range to the user from inside the vehicle is limited based on an attribute of the user.

According to an embodiment of the present disclosure, systems that allow visitors to facilities, such as factories, to be on board vehicles and tour the facilities can be improved.

### BRIEF DESCRIPTION OF THE DRAWINGS

In the accompanying drawings:

FIG. 1 is a block diagram illustrating a schematic configuration of an information processing system according to an embodiment;

FIG. 2 is a block diagram illustrating a schematic configuration of a vehicle;

FIG. 3 is a schematic diagram illustrating an example configuration to limit a visible range by a transmittance of a window;

FIG. 4 is a schematic diagram illustrating an example configuration to limit the visible range by a shutter;

FIG. 5 is a schematic diagram illustrating an example configuration to limit the visible range by slats;

FIG. 6 is a block diagram illustrating a schematic configuration of an information processing apparatus;

FIG. 7 is a conceptual diagram illustrating a factory tour according to the system according to the embodiment of the present disclosure; and

FIG. 8 is a flowchart illustrating an example procedure for an information processing method according to the embodiment.

### DETAILED DESCRIPTION

Hereinafter, an embodiment of the present disclosure will be described.

### Outline of Embodiment

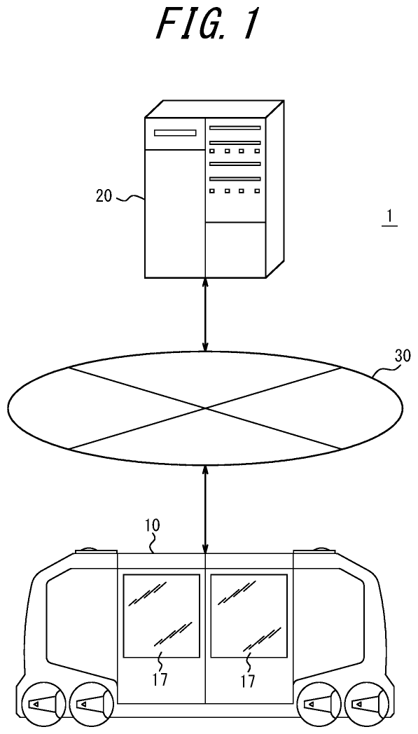

As illustrated in FIG. 1, an information processing system 1 according to an embodiment of the present disclosure includes a vehicle 10 and an information processing apparatus 20. The vehicle 10 and the information processing apparatus 20 are communicably connected to each other via a network 30 including, for example, the Internet, a mobile communication network, or the like.

In FIG. 1, for simplicity of explanation, the numbers of vehicles 10 and information processing apparatuses 20 provided in the information processing system 1 are one each, but not limited to this. The numbers of vehicles 10 and information processing apparatuses 20 provided in the information processing system 1 may be two or more, respectively, and may be arbitrarily determined.

The vehicle 10 is an automobile, for example, but is not limited to this, and may be any appropriate vehicle. The automobile is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The vehicle 10 may be a manned vehicle or any autonomous vehicle that travels unmanned.

The vehicle 10 travels in a facility such as a factory. The vehicle 10 has a cabin that can accommodate users, including customers associated with the facility or general users of the facility. The vehicle 10 travels in the facility with the users on board in the cabin and allows the users on board to observe the process of making products on a production line, for example, from inside the vehicle.

While not essential, the vehicle 10 may further include windows 17. The users may see the facility through the windows 17.

The information processing apparatus 20 is, for example, a computer such as a server apparatus. The information processing apparatus 20 is a server that belongs to a cloud computing system or another computing system. The information processing apparatus 20 is not limited to this, and may be any general purpose electronic device such as a personal computer (PC), or may be any other electronic device that is dedicated to the information processing system 1. The information processing apparatus 20 can communicate with the vehicle 10 via the network 30. In the present embodiment, the information processing apparatus 20 manages the operation of the vehicle 10 so that the vehicle 10 allows the users to be on board.

First, an outline of the present embodiment will be described, and details thereof will be described later. The vehicle 10 travels in the facility with users on board so that the users can observe a production line or the like. The term “in the facility” is not limited to indoors, but may also include outdoors.

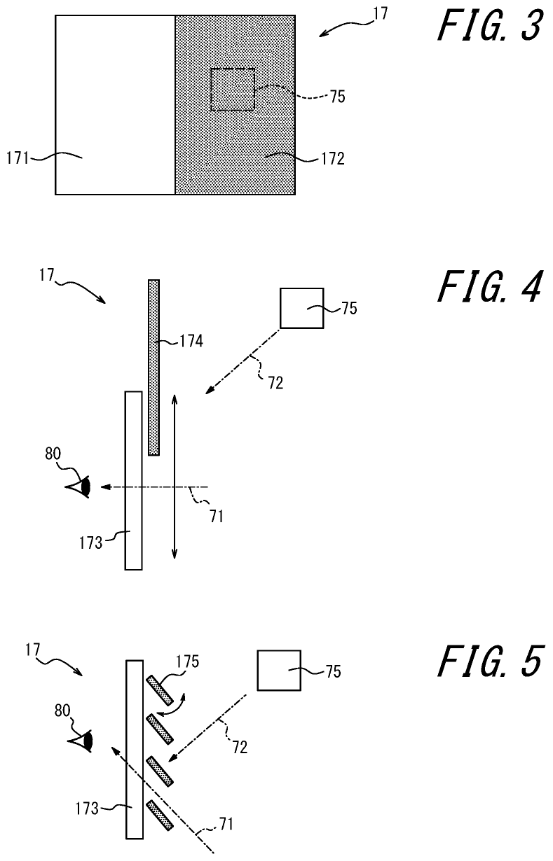

According to the present embodiment, the vehicle 10 with users on board travels to various locations in the facility and allow the users to tour the facility. There may be, in the facility, locations, objects, or tasks that should be kept secret from the users. The locations, objects, or tasks that should be kept secret from the users are also referred to as secret objects 75 (see FIG. 3 and the like). The information processing apparatus 20 manages the operation of the vehicle 10 so that the users are not allowed to see the secret objects 75. This makes it possible to manage secrecy or confidentiality within the facility, without making the users aware of the secrecy or confidentiality within the facility. As a result, technology related to systems that, in facilities such as factories, allow users to tour the facilities using vehicles 10 is improved.

(Configuration of Information Processing System 1)

A configuration of the information processing system 1 will be described below in detail.

Vehicle 10>

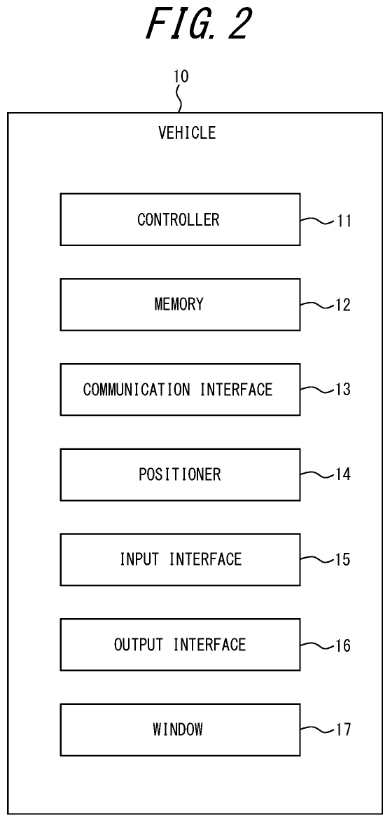

As illustrated in FIG. 2, the vehicle 10 includes a controller 11, a memory 12, a communication interface 13, a positioner 14, an input interface 15, an output interface 16, and a window 17.

The controller 11 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 11 executes processes related to operations of the vehicle 10 while controlling components of the vehicle 10.

The memory 12 includes one or more memories. The memories are, for example, semiconductor memories, magnetic memories, optical memories, or the like, but are not limited to these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memories included in the memory 12 may each function as, for example, a main memory, an auxiliary memory, or a cache memory. The memory 12 stores any information to be used for the operations of the vehicle 10. For example, the memory 12 may store a system program, an application program, embedded software, and the like. The information stored in the memory 12 may be updated with, for example, information acquired from the network 30 via the communication interface 13. In the present embodiment, the memory 12 can store any information necessary for traveling in a facility and touring a production line.

The communication interface 13 includes at least one interface for external communication for connecting to the network 30. The interface for communication is, for example, an interface compliant with a mobile communication standard such as a Long Term Evolution (LTE), the 4th generation (4G) standard, or the 5th generation (5G) standard, or an interface compliant with a short-range wireless communication standard such as Bluetooth® (Bluetooth is a registered trademark in Japan, other countries, or both), but is not limited to these. The communication interface 13 receives data to be used for the operations of the vehicle 10, and transmits data obtained by the operations of the vehicle 10 to the outside (e.g., information processing apparatus 20).

The positioner 14 includes one or more apparatuses for acquiring positional information on the vehicle 10. Specifically, the positioner 14 includes a receiver corresponding to a satellite positioning system such as the Global Positioning System (GPS), for example, but is not limited to this, and may include a receiver corresponding to any positioning system. The positioner 14 may acquire the positional information on the vehicle 10 continually, periodically, or non-periodically.

The input interface 15 includes an information input means into the vehicle 10. For example, the input interface 15 includes any imaging module capable of imaging the surroundings of the vehicle 10. The imaging module may include one or more cameras. The cameras may be arranged at appropriate positions on the vehicle 10 to enable imaging of the surroundings of the vehicle 10. The input interface 15 may also include an audio recognition function along with an audio information input means. Not limited to these, the input interface 15 may include any means for acquiring information on the surroundings of the vehicle 10. The input interface 15 may include a camera that images users who are on board the vehicle 10. The input interface 15 may detect the position of the users' line of sight from images of the users.

The output interface 16 includes at least one interface for output. The interface for output is, for example, a display apparatus for outputting information in the form of images, a speaker for outputting information in the form of audio, or the like. The display apparatus is, for example, a liquid crystal display (LCD) or organic electro luminescence (EL) display, but may also be a goggle-type display apparatus that displays virtual reality (VR) images. The output interface 16 outputs data received from the information processing apparatus 20, data obtained by the operations of the vehicle 10, and the like.

The window 17 allows light to pass through so that users who are on board the vehicle 10 can see the outside of the vehicle 10 from inside the vehicle 10. The window 17 may be configured as a simple opening. The window 17 may be configured to have a plate-shaped transparent member, such as a glass or acrylic plate.

As illustrated in FIG. 3, the window 17 may have a first area 171 corresponding to a range allowed to be seen by a user, and a second area 172 corresponding to a range not allowed to be seen by the user (range in which a secret object 75 is positioned).

The first area 171 may be configured to function as a high transmittance member to allow the user to see outside. In other words, the first area 171 may be configured to function as a transparent member.

The second area 172 may be configured to function as a low transmittance member not to allow the user to see a secret object 75. In other words, the second area 172 may be configured to function as an opaque member. The second area 172 may be configured to function as a member that diffusely reflects light, such as frosted or cut glass, so that the secret object 75 is not clearly visible from the user.

The window 17 may be configured such that the entire surface of the window 17 functions as the first area 171 in normal operation. The window 17 may be configured such that at least a portion of the window 17 functions as the second area 172 when a secret object 75 is present in a position visible through the window 17. In other words, at least a portion of the window 17 may be configured to function as the first area 171 in normal operation, while being capable of functioning as the second area 172 if necessary. Conversely, at least a portion of the window 17 may be configured to function as the second area 172 in normal operation, while being capable of functioning as the first area 171 if necessary. In other words, the window 17 may be configured to be capable of changing a transmittance at least at a portion.

For example, at least a portion of the window 17 may be configured as a liquid crystal panel to control a transmittance in response to the application of voltage, in order to prevent a user from seeing a secret object 75. For example, at least a portion of the window 17 may be configured as electronic frosted glass. For example, at least a portion of the window 17 may have a configuration that includes, on a surface or inside, a plurality of small reflective surfaces such as a Digital Mirror Device (DMD), or a configuration in which the reflective surfaces of the DMD are replaced by transmissive surfaces. At least a portion of the window 17 may be configured to change into a structure that diffusely reflects light, such as cut glass, by differently orienting the reflective or transmissive surfaces. For example, at least a portion of the window 17 may be configured to include a self-luminous panel, such as an organic or inorganic EL panel, thereby preventing a user from seeing a secret object 75 owing to light emitted from the self-luminous panel. At least a portion of the window 17 may be configured to be capable of displaying an image by means of a liquid crystal panel, a self-luminous panel, or the like.

As illustrated in FIG. 4, the window 17 may be provided with a shutter 174. The shutter 174 is configured to be capable of opening and closing at least a portion of the window 17. In other words, the shutter 174 is configured to be capable of passing or blocking light that passes through at least a portion of the window 17 and that is incident on a user's eye 80. When a secret object 75 is positioned within a visible range to a user through the window 17, the shutter 174 may be completely closed at a portion corresponding to the position of the secret object 75. The shutter 174 may close only a portion of the window 17 so that first light 71 arriving from a range that is allowed to be seen by a user reaches the user's eye 80 while second light 72 arriving from a secret object 75 does not reach the user's eye 80. A direction from which the first light 71 arrives is also referred to as a first direction. A direction from which the second light 72 arrives is also referred to as a second direction.

As illustrated in FIG. 5, the window 17 may be provided with slats 175. The slats 175 may be configured as strip-shaped members, like slats of a so-called blind, and to be turnable about a plane corresponding to an opening of the window 17. In other words, the slats 175 are configured to be capable of passing, reducing, or blocking light incident on a user's eye 80. When a secret object 75 is positioned within a visible range to a user through the window 17, the slats 175 may be turned to block light or reduce light to less than a predetermined percentage at a portion corresponding to the position of the secret object 75. The slats 175 may be turned at a predetermined angle so that first light 71 arriving from a range that is allowed to be seen by a user reaches the user's eye 80 while second light 72 arriving from a secret object 75 does not reach the user's eye 80.

In the configuration illustrated in FIG. 4 or FIG. 5, the window 17 may be provided with a plate-shaped transparent member 173, although this is not required. The transparent member 173 may be situated closer, as viewed from the user's eye 80, than the shutter 174 or slats 175. The transparent member 173 may be situated farther, as viewed from the user's eye 80, than the shutter 174 or slats 175. The transparent member 173 may be configured to incorporate the shutter 174 or slats 175 inside.

<Information Processing Apparatus 20>

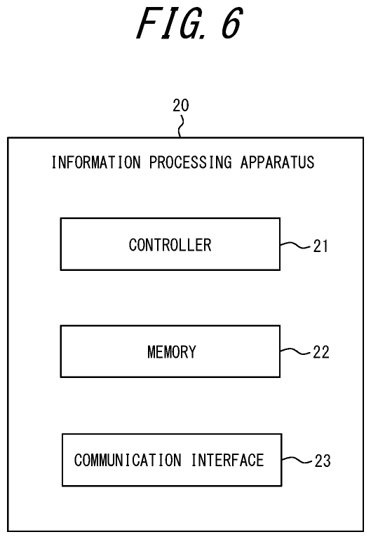

As illustrated in FIG. 6, the information processing apparatus 20 includes a controller 21, a memory 22, and a communication interface 23.

The controller 21 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 21 executes processes related to operations of the information processing apparatus 20 while controlling components of the information processing apparatus 20.

The memory 22 includes one or more memories. The memories are, for example, semiconductor memories, magnetic memories, optical memories, or the like, but are not limited to these. The semiconductor memory is, for example, RAM or ROM. The RAM is, for example, SRAM or DRAM. The ROM is, for example, EEPROM. The memories included in the memory 22 each function as, for example, a main memory, an auxiliary memory, or a cache memory. The memory 22 stores any information to be used for the operations of the information processing apparatus 20. For example, the memory 22 may store a system program, an application program, a database, and the like. The information stored in the memory 22 may be updated with, for example, information acquired from the network 30 via the communication interface 23. In the present embodiment, the memory 22 can store any information necessary for touring a production line, such as a tour schedule for the vehicle 10 and description information on tour spots.

The communication interface 23 includes at least one interface for external communication for connecting to the network 30. The interface for communication may be either a wired or wireless communication interface. For wired communication, the interface for communication is, for example, a Local Area Network (LAN) interface or Universal Serial Bus (USB). For wireless communication, the interface for communication is, for example, an interface compliant with a mobile communication standard such as LTE, the 4G standard, or the 5G standard, or an interface compliant with a short-range wireless communication standard such as Bluetooth®. The communication interface 23 receives data to be used for the operations of the information processing apparatus 20, and transmits data obtained by the operations of the information processing apparatus 20 to the outside. In the present embodiment, the information processing apparatus 20 communicates with the vehicle 10 via the communication interface 23 and the network 30. The information processing apparatus 20 may communicate with various apparatuses on the production line via the communication interface 23 and the network 30.

The information processing apparatus 20 in FIG. 6 according to the present embodiment may further include an input interface and an output interface. In other words, in addition to receiving (input) and transmitting (output) information via the communication interface 23, information may be input and output via the input and output interfaces included in the information processing apparatus 20.

The functions of the information processing apparatus 20 may be implemented by executing a program relating to an information processing method according to the present embodiment by a processor corresponding to the controller 21. That is, the functions of the information processing apparatus 20 are realized by software. The program causes a computer to execute the operations of the information processing apparatus 20, thereby causing the computer to function as the information processing apparatus 20. That is, the computer executes the operations of the information processing apparatus 20 in accordance with the program to thereby function as the information processing apparatus 20.

In the present embodiment, the program can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) on which the program is recorded. The program may also be distributed by storing the program in a storage of an external server and transmitting the program from the external server to another computer. The program may be provided as a program product.

### Example Operations of Information Processing System 1

Example operations of the information processing system 1 will be described below.

<Operation of Vehicle 10 for Facility Tour>

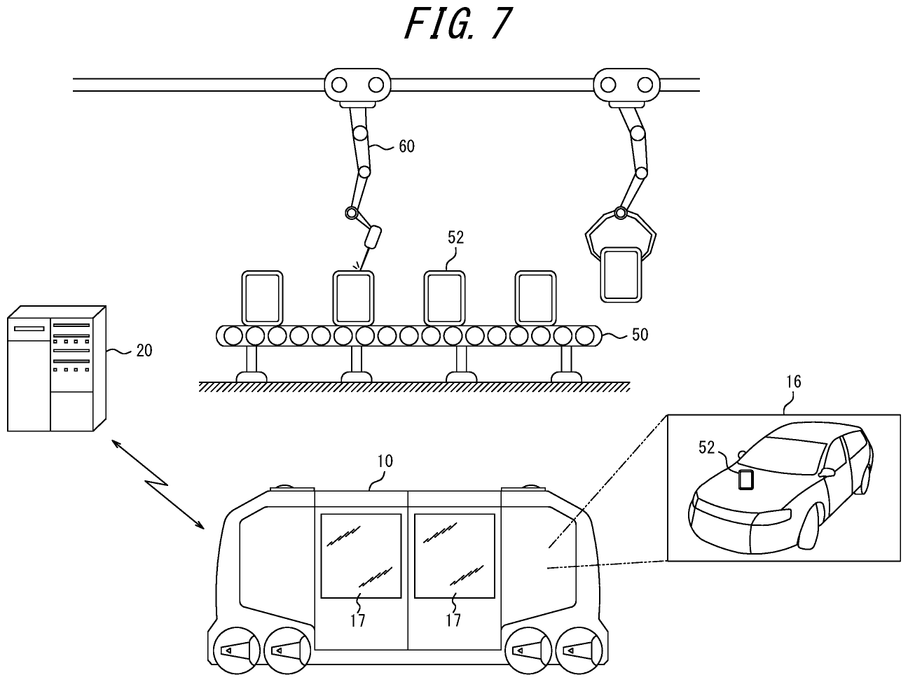

In the information processing system 1 according to the embodiment of the present disclosure, the vehicle 10 travels in a facility, such as a factory, and allows users on board the vehicle 10 to tour the facility, as illustrated in FIG. 7.

The vehicle 10 travels in the facility e.g. factory in accordance with a command from the information processing apparatus 20 (or a tour schedule stored in the memory 12 of the vehicle 10) with the users on board, and moves to locations at which a production line is to be observed. The locations at which the production line is to be observed are also hereinafter referred to as “tour spots”. The tour spots can be given by the information processing apparatus 20 as location information. The vehicle 10 can travel to the indicated tour spots by autonomous driving (automated driving). The tour spots may include, for example, the process of processing products on the production line. FIG. 7 illustrates a tour spot at which a robot arm 60 performs the machining or assembly of parts 52 on a conveyor belt 50. The following is example operations of the vehicle 10 when the vehicle 10 travels to allow the users to tour the production line.

The controller 21 of the information processing apparatus 20 may transmit, using the communication interface 23, location information on a tour spot to the vehicle 10. The tour spot may be determined, for example, based on a scheduled tour course and tour schedule. The vehicle 10 may receive, via the communication interface 13, the location information on the tour spot from the information processing apparatus 20. The vehicle 10 (controller 11) may move to the tour spot, for example, by autonomous driving, based on the location information on the tour spot and stored information on a travel route (route map) in the facility.

The vehicle 10 may control a display apparatus, as the output interface 16, to display information describing the tour spot. This makes it easier for the users to become interested in the tour spot. The display apparatus may be configured such that the magnification or orientation of displayed images can be freely changed by user operation. The display apparatus may display virtual reality (VR) images or stereoscopic images. The display apparatus may be configured as a head-mounted display worn by each user. The vehicle 10 may output audio information describing the tour spot from an audio output apparatus (speaker) as the output interface 16. This makes it easier for the users to become interested in the tour spot.

The vehicle 10 may acquire information regarding the tour spot from the information processing apparatus 20. The vehicle 10 may automatically acquire the information and provide the information to the user, or may acquire the information and provide the information to the user based on a request from the user.

After the vehicle 10 arrives at the tour spot, the controller 21 of the information processing apparatus 20 transmits location information on the next tour spot to the vehicle 10, for example, based on the tour schedule. The vehicle 10 may stay at the tour spot for a predetermined period of time, and then move to the next tour spot. The controller 21 may transmit, to the vehicle 10, time to stay at each tour spot.

As described above, the vehicle 10 travels around the tour spots in the facility with the users on board, thus allowing the users to tour the facility.

<Determination of Tour Schedule>

The controller 21 of the information processing apparatus 20 manages the operation of the vehicle 10 in the facility. Specifically, the controller 21 manages the operation of the vehicle 10 based on a tour request for the facility from users. The controller 21 may acquire, as the tour request from the users, information regarding time during which the users request a tour, or information regarding locations at which the users request a tour.

The controller 21 acquires the tour request from the users. The tour request may include the locations or time at which the users request a tour. The tour request may also include a request for a location at which the users get on the vehicle 10 for the tour or a location at which the users get off the vehicle 10 after the tour.

The controller 21 may generate a tour schedule based on the tour request from the users. The tour schedule may include information specifying locations or time the users are to tour. In other words, the controller 21 may determine, as the tour schedule, tour objects by way of which the vehicle 10 travels. The controller 21 may also determine, as the tour schedule, times at which the vehicle 10 arrives at the tour objects, or times at which the vehicle 10 passes through the tour objects. The tour schedule may include information specifying a location at which the users get on the vehicle 10 or a location at which the users get off. The tour schedule may include information specifying a time at which the users get on the vehicle 10 or a time at which the users get off.

The controller 21 further acquires information on an attribute of the users. The attribute of the users may include, for example, information identifying whether the users are mere visitors unrelated to the facility, whether the users are employees of the facility or affiliates such as outside vendors, or the like. In other words, the controller 21 may acquire, as the attribute of the uses, information identifying the relationship between the users and the facility. The attribute of the users may include, as a physical attribute of the uses, information identifying the position of the users' line of sight, for example.

As described above, in the facility, there are secret objects 75, such as locations, objects, or tasks, that should be kept secret from the users. One tour object should not be seen by certain users but may be allowed to be seen by others. In other words, one tour object may be or may not be a secret object 75 depending on the attribute of the users. The controller 21 may determine tour objects that correspond to secret objects 75 according to the attribute of the users.

The controller 21 may acquire, as the attribute of the uses, information identifying tour objects that should not be seen by the users. In other words, the controller 21 may acquire, as the attribute of the uses, information identifying secret objects 75 that are not allowed to be seen by the users in the facility.

The controller 21 may grant, to the users, admission permission information to the facility. The controller 21 may associate the admission permission information with the information identifying the tour objects that should not be seen by the users. In other words, the controller 21 may associate the admission permission information with the information identifying the secret objects 75.

The controller 21 may group the attribute of the users. For example, when the users are mere visitors unrelated to the facility, the controller 21 may classify the users' attribute as a first attribute. When the users are affiliates of the facility, the controller 21 may classify the users' attribute as a second attribute.

The controller 21 may group tour objects to be set as secret objects 75. For example, the controller 21 may classify tour objects that should not be seen by users who are mere visitors (users of the first attribute) into a first group. The controller 21 may classify tour objects that should not be seen by users who are affiliates of the facility (users of the second attribute) into a second group.

One tour object may be duplicately classified into both the first and second groups. One tour object may not be classified in either the first or second group. One tour object may be classified into only one of the first or second groups.

The controller 21 may set the tour objects classified into the first group as secret objects 75 for users of the first attribute. The controller 21 may set the tour objects classified in the second group as the secret objects 75 for users of the second attribute. The controller 21 may generate a list, table, or the like that associates tour objects to be set as secret objects 75 with each classification of the attribute of users.

The controller 21 may associate a classification of the attribute of users with admission permission information granted to the users. Based on the classification of the attribute of the users associated with the admission permission information, the controller 21 may extract secret objects 75 for the users from the list, table, or the like in which tour objects to be set as secret objects 75 are associated with each classification of the attribute of users. In other words, the controller 21 may associate admission permission information on users with information identifying secret objects 75 for the users.

The controller 21 may determine a tour schedule so that the users are not allowed to see the secret objects 75. In other words, the controller 21 may determine the tour schedule so that a visible range to the users from the vehicle 10 is limited. For example, the controller 21 may determine the tour schedule so that the vehicle 10 does not travel at locations where the secret objects 75 are visible from the vehicle 10. The controller 21 may determine the tour schedule so that, when the vehicle 10 travels near a secret object 75, the vehicle 10 travels on a route along which, for example, the window 17 does not face toward the secret object 75.

The controller 21 may predict a visible range to the users from inside the vehicle 10, which is determined according to the specification of the vehicle 10 and the condition of the vehicle 10, and determine the tour schedule so that the secret objects 75 are not within the visible range to the users. The specification of the vehicle 10 may include the external shape of the vehicle 10, or the position or size of the window 17. The condition of the vehicle 10 may include positional information on the vehicle 10, or an orientation to which the vehicle 10 is facing. The condition of the vehicle 10 may include the position of line of sight the users on board the vehicle 10.

<Control of Vehicle 10>

The controller 21 manages the operation of the vehicle 10 based on a tour route for the vehicle 10 and a scheduled time at which the vehicle 10 passes through each point along the tour route, which is included in the determined tour schedule. The controller 21 may output the tour schedule to the vehicle 10, and cause the vehicle 10 to travel autonomously based on the tour schedule. The controller 21 may generate information controlling the speed or acceleration, travel direction, and the like of the vehicle 10 based on the tour schedule, and output the information to the vehicle 10 to control the traveling of the vehicle 10.

When the vehicle 10 travels near a secret object 75, for example, there can be a difference between a predicted orientation of the vehicle 10 and an actual orientation of the vehicle 10. In addition, for the position of the users' line of sight inside the vehicle 10, there can be a difference between a predicted position and an actual position. Even though the vehicle 10 is traveling based on the tour schedule, the secret object 75 may be within an actual visible range to the users due to the difference in the orientation of the vehicle 10 or the difference in the position of the users' line of sight.

Therefore, when the vehicle 10 travels near a secret object 75, the controller 21 may calculate a visible range to the users from inside the vehicle 10 based on the actual condition of the vehicle 10. When the secret object 75 is within the visible range to the users from inside the vehicle 10, the controller 21 may cause the vehicle 10 to limit the visible range from the users. For example, the controller 21 may output information controlling the vehicle 10 to correct the orientation of the vehicle 10. The controller 21 may notify the vehicle 10 of an orientation error of the vehicle 10 and let the vehicle 10 correct the orientation autonomously.

The controller 11 of the vehicle 10 may limit the visible range from the users by controlling the window 17. In other words, the controller 21 of the information processing apparatus 20 may cause the vehicle 10 to control the window 17 to limit the visible range from the users.

The controller 11 of the vehicle 10 or the controller 21 of the information processing apparatus 20 may, for example, reduce the transmittance of the window 17 at a portion corresponding to a position at which the secret object 75 is visible from the users, so that the users cannot see the secret object 75. In other words, the controller 11 or the controller 21 may control the transmittance of at least a portion of the window 17.

The controller 11 of the vehicle 10 or the controller 21 of the information processing apparatus 20 may, for example, shield at least a portion of the window 17 by a shutter 174 (see FIG. 4) so that the secret object 75 is not visible from the users. The controller 11 or the controller 21 may reduce light passing through at least a portion of the window 17 by the shutter 174.

The controller 11 of the vehicle 10 or the controller 21 of the information processing apparatus 20 may reduce the transmittance of light (second light 72 in FIG. 4 or FIG. 5) arriving at the window 17 from a direction (second direction) along the line connecting the secret object 75 to each user so that the secret object 75 is not visible from the users. On the other hand, the controller 11 or the controller 21 may maintain the same transmittance of light (first light 71 in FIG. 4 or FIG. 5) arriving at the window 17 from a direction (first direction) along the line connecting a tour object that does not correspond to the secret object 75 to each user. In other words, the controller 21 may differentiate the transmittance of the first light 71 arriving at the window 17 from the first direction and the transmittance of the second light 72 arriving at the window 17 from the second direction. The controller 11 or the controller 21 may control the transmittance of light arriving at the window 17 from each direction based on the relationship between the shutter 174 and the position of the user's eye 80, or by an angle at which the slats 175 (see FIG. 5) are turned.

The controller 11 of the vehicle 10 or the controller 21 of the information processing apparatus 20 may, for example, display an image on the windows 17 at a portion corresponding to a position at which the secret object 75 is visible from the users, so that the users cannot see the secret object 75. In other words, the controller 11 or the controller 21 may display an image on at least a portion of the window 17. The controller 11 or the controller 21 may, for example, display a white image with a higher brightness than light arriving from the secret object 75. The controller 11 or the controller 21 may, for example, display an image that matches the scenery of the facility so that it is difficult for the users to see that the secret object 75 is hidden.

The controller 11 of the vehicle 10 or the controller 21 of the information processing apparatus 20 may guide the users' line of sight in a different direction from the direction of the secret object 75 so that the users do not see the secret object 75. The controller 11 or the controller 21 may guide the users' line of sight by, for example, displaying text, symbols, images, or the like that attract the users' attention on a display device as the output interface 16 installed in the vehicle 10. The controller 11 or the controller 21 may guide the users' line of sight by, for example, controlling a speaker, as the output interface 16 installed in the vehicle 10, to output audio that attracts the users' attention. In other words, the controller 11 or the controller 21 may guide the users' line of sight by outputting information from the output interface 16 installed in the vehicle 10, so that the users do not see the secret object 75.

### Flowchart of Example Operation Procedure Relating to Control of Vehicle 10

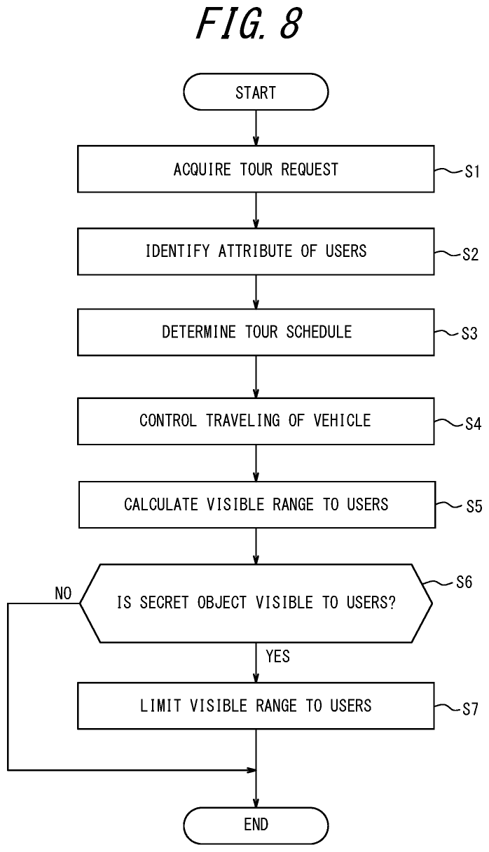

The controller 21 of the information processing apparatus 20 according to the present embodiment may perform an information processing method including a procedure of the flowchart in FIG. 8, for example, to control the vehicle 10. The information processing method may be implemented as an information processing program to be executed by the controller 21. The information processing program may be stored on a non-transitory computer readable medium.

The controller 21 acquires a tour request from users (step S1). The controller 21 identifies an attribute of the users (step S2). The controller 21 determines a tour schedule so that secret objects 75 determined based on the attribute of the users are not allowed to be seen by the users (step S3). The controller 21 controls the traveling of the vehicle 10 based on the determined tour schedule (step S4).

The controller 21 calculates an actual visible range to the users based on the condition of the vehicle 10 (step S5). The controller 21 determines whether a secret object 75 is within the actual visible range to the users. In other words, the controller 21 determines whether the secret object 75 is visible to the users from inside the vehicle 10 (step S6).

When the secret object 75 is visible to the users (YES in step S6), the controller 21 limits the visible range to the users by controlling the orientation of the vehicle 10, controlling the window 17, or the like (step S7). After performing the process of step S7, the controller 21 ends the procedure of the flowchart in FIG. 8. When the secret object 75 is not visible to the users (NO in step S6), the controller 21 ends the procedure of the flowchart in FIG. 8. After performing the process of step S6 or S7, the controller 21 may return to the process of step 4 in the control procedure for the traveling of the vehicle 10 and repeat the processes of steps S4 to S7.

<Summary>

As described above, according to the information processing apparatus 20, information processing method, and information processing program according to the embodiment of the present disclosure, a visible range to users touring a facility can be limited. By limiting the visible range to the users, secrecy or confidentiality within the facility may be maintained. In addition, by using various means to limit the visible range to the users, the users are unlikely to become aware of the limitation on the visible range. The user is less likely to be dissatisfied or stressed by not being aware of the limitation on the visible range. As a result, a system that allows visitors to a facility, such as a factory, to be on board the vehicle 10 and tour the facility can be improved.

### Example Operation of Vehicle 10

The vehicle 10 according to the present embodiment, with users touring a facility on board, travels in the facility based on a tour schedule determined based on an attribute of the users. The controller 11 of the vehicle 10 controls the traveling of the vehicle 10.

The vehicle 10 is provided with a window 17 through which the users tour the facility from inside the vehicle 10. The controller 11 of the vehicle 10 controls the window 17 to limit a visible range to the users from inside the vehicle 10 based on an attribute of the users.

For example, the controller 11 may control the window 17 so that a secret object 75 that is not allowed to be seen by the users in the facility is outside the visible range to the users from inside the vehicle 10. The controller 11 may control the transmittance of at least a portion of the window 17 so that the secret object 75 is not visible to the users. The controller 11 may control the transmittance of the window 17 to reduce the transmittance of light arriving from a direction (second direction) of the secret object 75 so that the secret object 75 is not visible to the users. The controller 11 may control the transmittance of the window 17 to maintain the transmittance of light arriving from a direction (first direction) without the secret object 75, so that portions other than the secret object 75 are visible to the users. In this way, the limitation on the users' view can be kept to the minimum necessary. As a result, the users are less likely to feel dissatisfied or stressed.

For example, the controller 11 may limit the visible range to the users by controlling a shutter 174 or slats 175 of the window 17. The controller 11 may display an image on at least a portion of the window 17 so that the users cannot see the secret object 75, i.e., to limit the visible range to the users.

The controller 11 may display, on at least a portion of the window 17, an image guiding the users' line of sight so that the users do not see the secret object 75. The controller 11 may output, from the output interface 16, information guiding the users' line of sight so that the users do not see the secret object 75. Thereby, the users are less likely to become aware of that the secret object 75 is hidden. As a result, the users are less likely to feel dissatisfied or stressed.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the vehicle 10 can also be implemented.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Part of the embodiment of the present disclosure is described below. However, it should be noted that the embodiment of the present disclosure is not limited to these examples.

[Appendix 1] An information processing apparatus comprising a controller configured to manage operation of a vehicle traveling in a facility,
wherein the controller is configured to:
   determine a tour schedule to allow a user touring the facility to be on board the vehicle so that a visible range to the user is limited based on an attribute of the user; and
   control the vehicle based on the tour schedule.
      [Appendix 2] The information processing apparatus according to appendix 1, wherein the controller is configured to acquire, as the attribute of the user, information identifying the user's relationship to the facility.
      [Appendix 3] The information processing apparatus according to appendix 1 or 2, wherein the controller is configured to determine, as the tour schedule, the user's tour object by way of which the vehicle travels, or a time at which the vehicle arrives at or passes through the tour object.
      [Appendix 4] The information processing apparatus according to any one of appendices 1 to 3, wherein the controller is configured to:
acquire, as the attribute of the user, information identifying a secret object being not allowed to be seen by the user in the facility; and
determine the tour schedule not to allow the user to see the secret object.
   [Appendix 5] The information processing apparatus according to appendix 4, wherein the controller is configured to:
grant to the user, as the attribute of the user, admission permission information to the facility; and
associate the information identifying the secret object with the admission permission information.
   [Appendix 6] The information processing apparatus according to appendix 4 or 5, wherein the controller is configured to:
predict the visible range to the user from inside the vehicle, the visible range being determined according to a specification of the vehicle and a condition of the vehicle; and
determine the tour schedule so that the secret object is not within the visible range to the user.
   [Appendix 7] The information processing apparatus according to appendix 6, wherein the controller is configured to cause the vehicle to limit the visible range to the user when the secret object is within the visible range to the user from inside the vehicle.
   [Appendix 8] The information processing apparatus according to appendix 7, wherein the controller is configured to control a transmittance of at least a portion of a window of the vehicle.
   [Appendix 9] The information processing apparatus according to appendix 8, wherein the controller is configured to differentiate a transmittance of light arriving at the window from a first direction and a transmittance of light arriving at the window from a second direction.
   [Appendix 10] The information processing apparatus according to any one of appendices 7 to 9, wherein the controller is configured to display an image on at least a portion of a window of the vehicle.
   [Appendix 11] The information processing apparatus according to any one of appendices 4 to 10, wherein the controller is configured to output information from an output interface installed in the vehicle so that the user is not allowed to see the secret object.
   [Appendix 12] An information processing system comprising:
the information processing apparatus according to any one of appendices 1 to 11; and
a vehicle whose operation is managed by the information processing apparatus.
   [Appendix 13] An information processing method configured to manage operation of a vehicle traveling in a facility, the information processing method comprising:
determining a tour schedule to allow a user touring the facility to be on board the vehicle so that a visible range to the user is limited based on an attribute of the user; and
controlling the vehicle based on the tour schedule.
   [Appendix 14] A vehicle configured to travel in a facility with a user touring the facility on board, the vehicle comprising:
a controller configured to control traveling of the vehicle based on a tour schedule determined based on an attribute of the user; and
a window configured to allow the user to see the facility from inside the vehicle,
wherein the controller is configured to control the window so that a visible range to the user from inside the vehicle is limited based on the attribute of the user.
   [Appendix 15] The vehicle according to appendix 14, wherein the controller is configured to control the window so that a secret object being not allowed to be seen by the user in the facility is out of the visible range to the user from inside the vehicle.
   [Appendix 16] The vehicle according to appendix 15, wherein
the window is configured to be capable of changing a transmittance at least at a portion, and
the controller is configured to control a transmittance of at least the portion of the window.
   [Appendix 17] The vehicle according to appendix 16, wherein the window is configured to differentiate a transmittance of light arriving at the window from a first direction and a transmittance of light arriving at the window from a second direction.
   [Appendix 18] The vehicle according to any one of appendices 14 to 17, wherein the window comprises a shutter configured to be openable and closable and/or a slat configured to be turnable.
   [Appendix 19] The vehicle according to any one of appendices 14 to 18, wherein
the window is configured to be capable of displaying an image on at least a portion, and
the controller is configured to control at least the portion of the window to display an image limiting the visible range to the user or an image guiding the user's line of sight.
   [Appendix 20] The vehicle according to any one of appendices 14 to 19, further comprising an output interface,
wherein the controller is configured to control the output interface to output information guiding the user's line of sight.

1. An information processing apparatus comprising a controller configured to manage operation of a vehicle traveling in a facility,
wherein the controller is configured to:
determine a tour schedule to allow a user touring the facility to be on board the vehicle so that a visible range to the user is limited based on an attribute of the user; and
control the vehicle based on the tour schedule.

2. The information processing apparatus according to claim 1, wherein the controller is configured to acquire, as the attribute of the user, information identifying the user's relationship to the facility.

3. The information processing apparatus according to claim 1, wherein the controller is configured to determine, as the tour schedule, the user's tour object by way of which the vehicle travels, or a time at which the vehicle arrives at or passes through the tour object.

4. The information processing apparatus according to claim 1, wherein the controller is configured to:
acquire, as the attribute of the user, information identifying a secret object being not allowed to be seen by the user in the facility; and
determine the tour schedule not to allow the user to see the secret object.

5. The information processing apparatus according to claim 4, wherein the controller is configured to:
grant to the user, as the attribute of the user, admission permission information to the facility; and
associate the information identifying the secret object with the admission permission information.

6. The information processing apparatus according to claim 4, wherein the controller is configured to:
predict the visible range to the user from inside the vehicle, the visible range being determined according to a specification of the vehicle and a condition of the vehicle; and
determine the tour schedule so that the secret object is not within the visible range to the user.

7. The information processing apparatus according to claim 6, wherein the controller is configured to cause the vehicle to limit the visible range to the user when the secret object is within the visible range to the user from inside the vehicle.

8. The information processing apparatus according to claim 7, wherein the controller is configured to control a transmittance of at least a portion of a window of the vehicle.

9. The information processing apparatus according to claim 8, wherein the controller is configured to differentiate a transmittance of light arriving at the window from a first direction and a transmittance of light arriving at the window from a second direction.

10. The information processing apparatus according to claim 7, wherein the controller is configured to display an image on at least a portion of a window of the vehicle.

11. The information processing apparatus according to claim 4, wherein the controller is configured to output information from an output interface installed in the vehicle so that the user is not allowed to see the secret object.

12. An information processing system comprising:
the information processing apparatus according to claim 1; and
a vehicle whose operation is managed by the information processing apparatus.

13. An information processing method configured to manage operation of a vehicle traveling in a facility, the information processing method comprising:
determining a tour schedule to allow a user touring the facility to be on board the vehicle so that a visible range to the user is limited based on an attribute of the user; and
controlling the vehicle based on the tour schedule.

14. A vehicle configured to travel in a facility with a user touring the facility on board, the vehicle comprising:
a controller configured to control traveling of the vehicle based on a tour schedule determined based on an attribute of the user; and
a window configured to allow the user to see the facility from inside the vehicle,
wherein the controller is configured to control the window so that a visible range to the user from inside the vehicle is limited based on the attribute of the user.

15. The vehicle according to claim 14, wherein the controller is configured to control the window so that a secret object being not allowed to be seen by the user in the facility is out of the visible range to the user from inside the vehicle.

16. The vehicle according to claim 15, wherein
the window is configured to be capable of changing a transmittance at least at a portion, and
the controller is configured to control a transmittance of at least the portion of the window.

17. The vehicle according to claim 16, wherein the window is configured to differentiate a transmittance of light arriving at the window from a first direction and a transmittance of light arriving at the window from a second direction.

18. The vehicle according to claim 14, wherein the window comprises a shutter configured to be openable and closable and/or a slat configured to be turnable.

19. The vehicle according to claim 14, wherein
the window is configured to be capable of displaying an image on at least a portion, and
the controller is configured to control at least the portion of the window to display an image limiting the visible range to the user or an image guiding the user's line of sight.

20. The vehicle according to claim 14, further comprising an output interface,
wherein the controller is configured to control the output interface to output information guiding the user's line of sight.
